(19) United States
(12) Patent Application Publication
(10) Pub. No.: US 2012/0194614 A1
(43) Pub. Date: Aug. 2, 2012

(54) INKJET PRINTING APPARATUS AND INKJET PRINTING METHOD

(75) Inventor: Yoshitomo Marumoto, Kawasaki-shi (JP)

(73) Assignee: CANON KABUSHIKI KAISHA, Tokyo (JP)

(21) Appl. No.: 13/358,688

(22) Filed: Jan. 26, 2012

(30) Foreign Application Priority Data
Feb. 2, 2011 (JP) 2011-020824

(51) Int. Cl. B41J 23/00

(52) U.S. Cl. 347/37

(57) ABSTRACT

A nozzle use range and a nozzle nonuse range are set in nozzles of a print head. In a forward direction printing in the first pas, printing is performed by the use nozzles thus set. After the first pass is performed, a print medium is conveyed by a nozzle arrangement length of the nozzle nonuse range in a conveyance direction. Along with it, the nozzle use range and the nozzle nonuse range for the second pass are set by shifting the nozzle use range. The backward direction printing in the second pass is performed in the nozzle use range thus set. Printing in an area having a width equivalent to a nozzle arrangement length of the use nozzles can be completed by the two passes in the forward and backward directions. A raster in the area to be printed is printed by the two different nozzles.

### BACKGROUND OF THE INVENTION

1. Field of the Invention

The present invention relates to an inkjet printing apparatus and an inkjet printing method, and in particular to a technology for performing a multi-pass printing in which printing in a predetermined area is completed by a plurality of scans.

2. Description of the Related Art

The multi-pass printing is a method which performs printing of a unit area, which is a unit of an area for completing printing, by a plurality of scans of a print head, and conveys a print medium by a width of the unit area between the plurality of scans to differentiate nozzles in the print head for printing the unit area. This method can reduce so-called stripe like density unevenness. More specifically, there are some cases where, when ejection characteristics of nozzles in a nozzle array are not uniform, for example, an ejection direction of the nozzle is shifted slightly from a normal direction and an ejection quantity thereof is different, and thereby a printing density by ink ejected from the nozzle is darker or lighter than that of the other. As a result, the phenomenon appears as stripe like density unevenness in a printed image. In contrast to this, when the aforementioned multi-pass printing is performed, since the nozzle for printing each raster in the unit area can be constructed of a plurality of different nozzles, it is possible to disperse the variations in the ejection characteristics between the respective nozzles described above, which enables the stripe like density unevenness not to be noticeable.

However, when a print head of a so-called lateral arrangement, in which nozzle arrays of a plurality of ink colors are respectively arranged in the scan direction, is used to perform a bidirectional multi-pass printing, there may occur a problem with an image defect called inter-band unevenness. More specifically, in the bidirectional multi-pass printing, a unit area where the printing starts in the forward direction and a unit area where the printing starts in the backward direction are alternately generated, and there occurs a difference in coloring due to a difference in an ejecting order of ink between the two unit areas. As a result, the difference in coloring possibly causes unevenness, leading to degradation of image quality.

To this problem, Japanese Patent Laid-Open No. S58-194541 (1983) describes a technology which performs scanning by a print head in a forward direction and use all nozzles in a nozzle array to print a thinned out image of 50%, and thereafter, without conveying a print medium, performs scanning by the print head in a backward direction and prints the remaining thinned out image of 50%, thus completing the printing of the area. Then, conveyance of the print medium equivalent to a width of the nozzle array is carried out. Such scans of the print head in the forward and backward directions and the conveyance of the print medium are repeated to perform printing on the print medium. That is, according to the printing method of Japanese Patent Laid-Open No. S58-194541 (1983), the scans of the print head in the forward and backward directions and the conveyance of the print medium are alternately repeated to the unit area equivalent to the nozzle array width to complete the image for each unit area equivalent to the nozzle array width.

According to Japanese Patent Laid-Open No. S58-194541 (1983), since the printing is made in the order corresponding to a forward scan and a backward scan of the print head in any unit area, it is possible to suppress degradation of the image quality due to the inter-band unevenness.

However, in the method of Japanese Patent Laid-Open No. S58-194541 (1983), scanning of the print head is performed a plurality of times to each unit area, but the printing is performed in each raster with the same nozzle. Therefore, this method can not achieve the effect that the variation in the ejection characteristic for each nozzle is dispersed, thereby causing the stripe like unevenness not to be noticeable.

### SUMMARY OF THE INVENTION

An object of the present invention is to provide an inkjet printing apparatus and an inkjet printing method which can suppress generation of inter band unevenness and disperse variations in ejection characteristics between respective nozzles to perform printing with less stripe like unevenness.

In a first aspect of the present invention, there is provided an ink jet printing apparatus that performs scans of a print head, in which a plurality of nozzle arrays for ejecting different colors of inks from each other in a predetermined direction, in a first direction that is the predetermined direction and in a second direction opposing the first direction, and conveys a print medium in a conveyance direction crossing the predetermined direction, to print an image to the print medium, the apparatus comprising: a printing unit configured to perform printing to a unit area of the print medium by using a range of nozzles that is obtained by excluding a predetermined number of nozzles from the end of a downstream side in the conveyance direction of the nozzle array from nozzles in each of the plurality of nozzle arrays, in a scan of the first direction, and to perform printing to the unit area of the print medium by using a range of nozzles that is obtained by excluding the predetermined number of nozzles from the end of a upstream side in the conveyance direction of the nozzle array from nozzles in each of the plurality of nozzle arrays, in a scan of the second direction; and a conveying unit configured to convey the print medium by an amount corresponding to a nozzle arrangement length of the predetermined number of nozzles, between the scan of the first direction and the scan of the second direction.

In a second aspect of the present invention, there is provided an ink jet printing apparatus that performs scans of a print head, in which a plurality of nozzle arrays for ejecting different colors of inks from each other in a predetermined direction, in a first direction that is the predetermined direction and in a second direction opposing the first direction, and conveys a print medium in a conveyance direction crossing the predetermined direction, to print an image to the print medium, the apparatus comprising: a printing unit configured to execute a first step that performs printing to a unit area of the print medium by using a range of nozzles that is obtained by excluding a predetermined number of nozzles from the end of a downstream side in the conveyance direction of the nozzle array from nozzles in each of the plurality of nozzle arrays, in a scan of the first direction, and a second step that performs printing to the unit area of the print medium by using a range of nozzles that is obtained by excluding the predetermined number of nozzles from the end of a upstream side in the conveyance direction of the nozzle array from nozzles in each of the plurality of nozzle arrays, in a scan of the second direction; and a conveying unit configured to convey the print medium by an amount corresponding to a nozzle arrangement length of the predetermined number of nozzles, between the first step and the second step.

In a third aspect of the present invention, there is provided an ink jet printing method of performing scans of a print head, in which a plurality of nozzle arrays for ejecting different colors of inks from each other in a predetermined direction, in a first direction that is the predetermined direction and in a second direction opposing the first direction, and of conveying a print medium in a conveyance direction crossing the predetermined direction, to print an image to the print medium, the method comprising: a first step of performing printing to a unit area of the print medium by using a range of nozzles that is obtained by excluding a predetermined number of nozzles from the end of a downstream side in the conveyance direction of the nozzle array from nozzles in each of the plurality of nozzle arrays, in a scan of the first direction, and a second step of performing printing to the unit area of the print medium by using a range of nozzles that is obtained by excluding the predetermined number of nozzles from the end of a upstream side in the conveyance direction of the nozzle array from nozzles in each of the plurality of nozzle arrays, in a scan of the second direction; and a conveying step of conveying the print medium by an amount corresponding to a nozzle arrangement length of the predetermined number of nozzles, between the first step and the second step.

According to the above structure, the generation of the inter-band unevenness can be suppressed and the variations in the ejection characteristics between the respective nozzles can be dispersed to perform the printing with less stripe like unevenness.

Further features of the present invention will become apparent from the following description of exemplary embodiments (with reference to the attached drawings).

### BRIEF DESCRIPTION OF THE DRAWINGS

FIG. 1 is a perspective view explaining a schematic construction of an inkjet printing apparatus in an embodiment according to the present invention;

FIG. 2 is a diagram schematically showing a nozzle arrangement in a print head in the present embodiment explained in FIG. 1;

FIG. 3 is a block diagram showing a printing system in an embodiment according to the present invention constructed by a host apparatus and the printing apparatus shown in FIG. 1;

FIG. 4 is a diagram explaining a multi-pass printing operation of two passes in a comparison example of a multi-pass printing operation according to a first embodiment of the present invention;

FIG. 5 is a diagram explaining a multi-pass printing operation of two passes according to the first embodiment of the present invention;

FIG. 6 is a diagram explaining a special size of each of a nozzle use range, a nozzle nonuse range and the like in a printing operation in the present embodiment explained by referring to FIG. 5;

FIG. 7 is a diagram explaining a multi-pass printing operation according to a second embodiment of the present invention;

FIG. 8 is a diagram explaining a special size of each of a nozzle use range, a nozzle nonuse range and the like in a printing operation in the present embodiment explained by referring to FIG. 7;

FIG. 9 is a diagram explaining masks used in a two-pass print explained by referring to FIG. 5;

FIG. 10 is a flowchart showing a connection process applicable in an embodiment of the present invention;

FIG. 11 is a diagram showing an area for counting data showing ink ejection in the connection process; and

FIG. 12 is a diagram showing an example of a relation between a thinning level and a thinning rate in the connection process.

### DESCRIPTION OF THE EMBODIMENTS

Hereinafter, embodiments according to the present invention will be in detail explained with reference to the accompanying drawings.

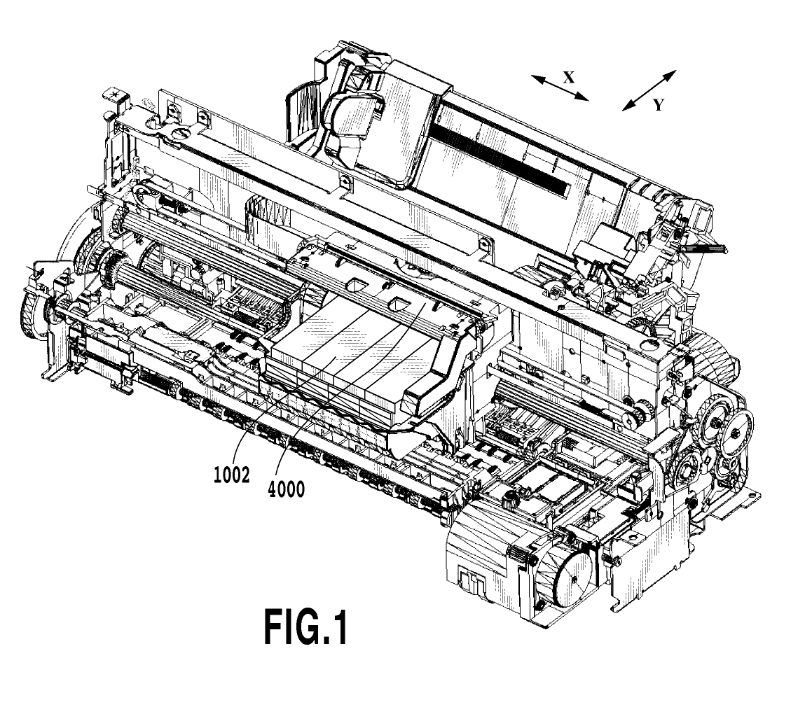

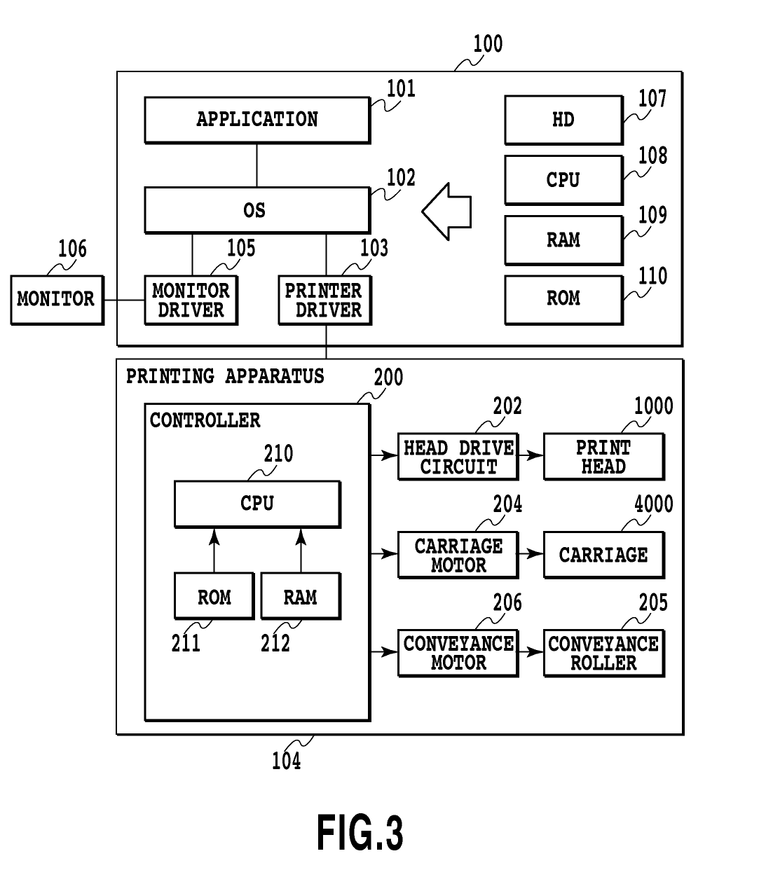

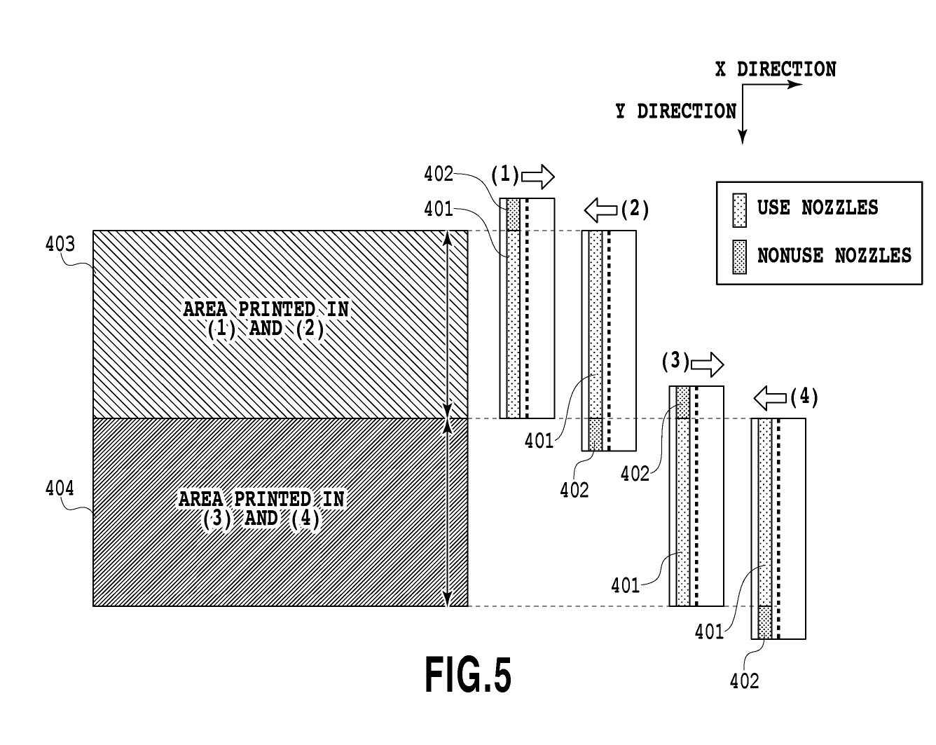

FIG. 1 is a perspective view explaining a schematic construction of an inkjet printing apparatus according to an embodiment in the present invention. A carriage 4000 as a mechanism for moving a print head mounts the print head thereon, which is equipped with four nozzle groups each ejecting cyan (C), magenta (M), yellow (Y), and black (K) respectively. In addition, the carriage 4000 removably mounts ink tanks 1000 thereon, each receiving inks of the four colors of C, M, Y, and K respectively. A control unit, which will be described later in FIG. 3, is constructed of a controller and the like, and controls the print head to perform an ink ejection operation during the moving (scanning) by the carriage 4000 in the X direction according to image data received from a host apparatus. When a scan of one time by such a print head is completed, a print medium is conveyed by a conveyance amount in a multi-pass printing in the Y direction crossing the X direction by a conveyance mechanism made up of a conveyance roller and the like, which will be in detail described later in FIG. 5. After that, the printing caused by the movement (scan) of the print head in the X direction and the conveying of the print medium in the Y direction are repeated to sequentially print an image on the print medium.

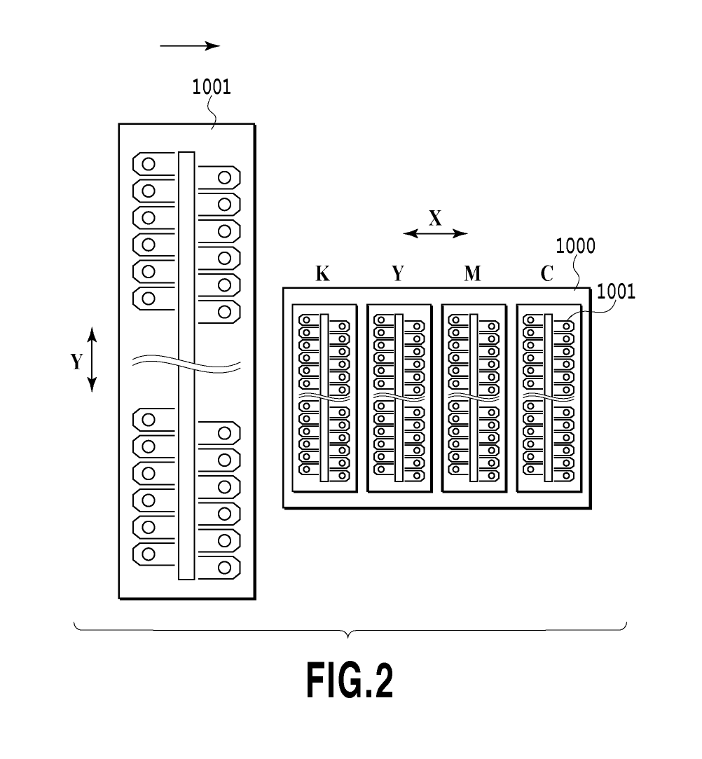

FIG. 2 is a diagram schematically showing a nozzle arrangement in the print head of the present embodiment explained in FIG. 1. The print head 1000 in the present embodiment is provided with four nozzle groups 1001 arranged in the X direction (scan direction), each ejecting four kinds of inks of C, M, Y, and K respectively as described above. The nozzle groups 1001 of the respective colors are provided with 1280 nozzles arranged in each nozzle group in the Y direction. In detail, the nozzle group 1001 of each color has two nozzle arrays each of which is provided with 640 nozzles arranged in a pitch equivalent to 600 dpi in the Y direction, and these two nozzle arrays are arranged to be shifted by a half pitch with each other in the Y direction. That is, the print head 1000 ejects ink from the individual nozzles while scanning in the X direction, thus making it possible to print an image having a resolution of 1200 dpi (dot/inch) in the Y direction. It should be noted that the above explanation is made of an example in which the arrangement direction of the plurality of nozzles ejecting the ink is in agreement with the conveyance direction (Y direction) of the print medium. However, the nozzle arrangement direction maybe not necessarily in agreement with the conveyance direction of the print medium. It is apparent from the following explanation that the present invention can be applied even in a case where the arrangement direction of the nozzle is inclined slightly to the Y direction.

FIG. 3 is a block diagram showing a printing system according to an embodiment in the present invention, which is constructed of a host apparatus and the printing apparatus shown in FIG. 1.

In the host apparatus 100, a CPU 108 operates each software of an application 101, a printer driver 103, and a monitor driver 105 via an operating system 102 according to various programs stored in a hard disc (HD) 107 and a ROM 110. At this time, a RAM 109 is used as a work area for performing various processes. The monitor driver 105 is the software for performing the process of generating image data to be displayed on a monitor 106, and the like. The printer driver 103 performs the process in which image data supplied from the application software 101 to the OS 102 is converted into multi-level or binary image data receivable by the printing apparatus 104, which is transmitted to the printing apparatus 104.

The printing apparatus 104 is equipped with a controller 200, the print head 1000, a head drive circuit 201, the carriage 4000, a carriage motor 204, a conveyance roller 205, a conveyance motor 206, and the like. The head drive circuit 202 drives the print head 1000 to eject ink. A driving force of the carriage motor 204 enables the carriage 4000 to reciprocate. In addition, a driving force of the conveyance motor 206 enables the conveyance roller 205 for conveying the print medium to be driven. The controller 200 is provided with a CPU 210 in the form of a microprocessor, a ROM 211 in which control programs and the like are stored, a RAM. 212 used at the time the CPU performs the process of image data and the like, and the like. The ROM 211 stores therein mask patterns which will be described later, control programs for controlling the multi-pass printing, and the like. The controller 200 controls the head drive circuit 202, the carriage motor 204, and the conveyance motor 206 for performing the multi-pass printing, for example, and besides, generates image data corresponding to each scan of the multi-pass printing. In detail, the controller 200 reads out a mask pattern from the ROM 211 according the control program and uses the read mask pattern to divide image data corresponding to a unit area into printing data which should be printed by a nozzle block corresponding to each scan of the multi-pass printing. The controller 200 controls the head drive circuit 202 such that ink is ejected from the print head 1000 according to the divided image data.

Several embodiments of the multi-pass printing to which the present invention is applied, in the inkjet printing apparatus according to the embodiment of the present invention explained above, will be explained below.

### First Embodiment

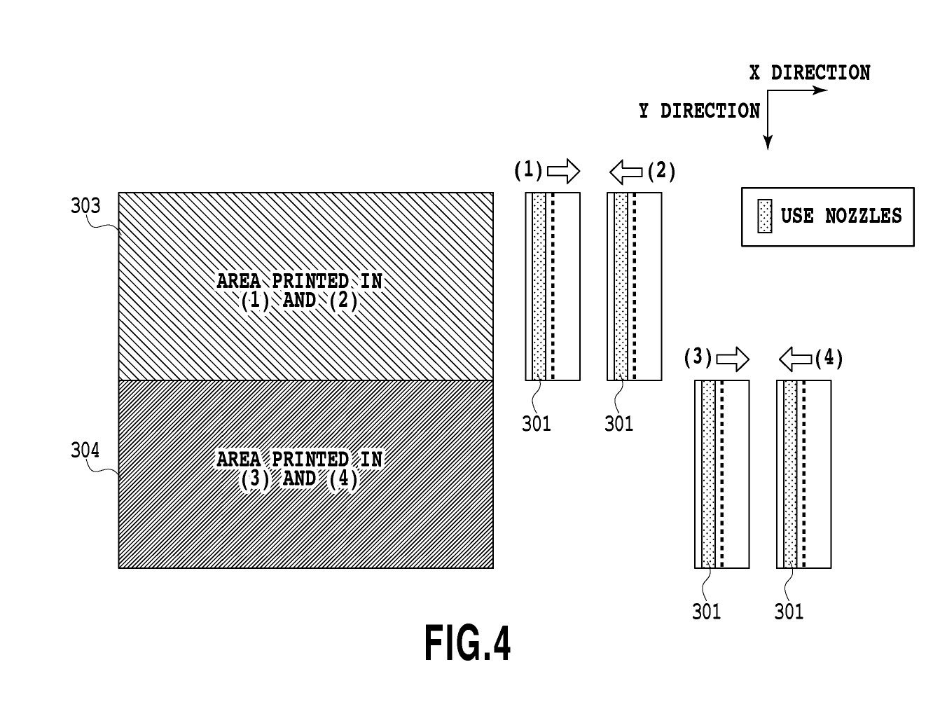

FIGS. 4 and 5 are diagrams each explaining a multi-pass printing operation according to a first embodiment of the present invention, and in detail, FIG. 4 shows a multi-pass printing operation of two passes according to a comparison example and FIG. 5 shows a multi-pass printing operation of two passes according to the first embodiment.

The comparison example shown in FIG. 4 is a printing method disclosed in Japanese Patent Laid-Open No. S58-194541 (1983), which shows a printing operation for completing the printing with two passes in forward and backward scans. In the comparison example, the printing is performed using a nozzle use range 301 of the print head in the first pass (first scan) (1) of the forward direction in the X direction and the printing is performed using the same nozzle use range 301 of the print head in the second pass (2) of the backward direction. The printing in an area 303 of the print medium is completed by twice scans made up of the forward direction scan and the backward direction scan. Next, the print medium is conveyed by an amount corresponding to a width of the nozzle use range in the Y direction. Then, as similar to the above, the printing is performed using the nozzle use range 301 of the print head in the first pass (3) in the forward direction and the printing is performed using the same nozzle use range 301 of the print head in the second pass (4) of the backward direction. The printing in an area 304 of the print medium is completed by twice scans made up of these forward direction and the backward direction scans.

In this manner, in the bidirectional printing of the forward and backward directions, the printing in one area (303) is completed and then, the printing in the next area (304) is started as in the case of the above comparison example. Therefore, so-called inter-band unevenness between the areas where the printing is sequentially completed can be reduced. More specifically, the printing starts in the forward direction scan from left to right in any of the area (303) and the area (304), and a printing time difference in the scan direction between the forward and backward scans becomes equal in any area, causing no inter-band unevenness in principle. In addition, when the nozzle use range 301 is defined as all nozzles of the nozzle array in the print head, the printing can be performed in a high speed.

In a case of the comparison example shown in FIG. 4, however, the effect that used nozzles are dispersed by the multi-pass printing can not be obtained. The printing in each of the areas 303 and 304 is performed in the first pass of the forward direction and in the second pass of the backward direction, but since the print medium does not move in the Y direction between the first pass and the second pass, each raster on the print medium is resultantly printed by the same nozzle. In consequence, an influence of ejection characteristics (ejection amount and ejection direction) of the nozzle tends to easily occur on each raster, and the stripe like unevenness is generated as a result. That is, the effect of dispersing the ejection characteristics of the nozzle by the multi-pass printing can not be obtained.

On the contrary, the first embodiment of the present invention can obtain the effect of the multi-pass printing and is also designed not to cause the inter-band unevenness.

More specifically, the present embodiment shifts a use range of nozzles between the first pass and the second pass and conveys the print medium by an arrangement length corresponding to nozzles unused between the first pass and the second pass.

Specially, as shown in FIG. 5, a nozzle use range 401 and a nozzle nonuse range 402 are set in the nozzles of the print head. Printing is performed by use nozzles thus set in the forward direction printing (1) of a first pass. After this first pass is completed, the print medium is conveyed by a nozzle arrangement length of the nozzle nonuse range 402 in a direction (conveyance direction) opposing the Y direction. Along with this, a nozzle use range 401 and a nozzle nonuse range 402 for the second pass are set in the nozzles of the print head. The nozzle range set at this time corresponds to the above shift amount of the use range of nozzles. That is, this range for the second pass is the same as a size of the range set for the first pass, that is, the number of the nozzles, but a range of the nozzles set for each is different. Specially, the nozzle nonuse range 402 for the first pass is set at the upper end side (downstream side in the conveyance direction) in the nozzle arrangement, and on the other hand, the nozzle nonuse range 402 for the second pass is set at the lower end side (upstream side in the conveyance direction) in the nozzle array. With the nozzle use range set in this manner, the forward direction printing (2) of the second pass is performed. In consequence, the two passes of the forward and backward directions enable the printing of the area 403 having a width equivalent to a nozzle arrangement length of the use nozzles to be completed. In addition, each raster of the area 403 will be printed with two different nozzles.

Next, the print medium is conveyed by a difference amount found by subtracting a nozzle arrangement length of the nozzle nonuse range 402 from a nozzle arrangement length of the nozzle use range 401 in a direction (conveyance direction) opposing the Y direction. Along with it, the same range of each of the nozzle nonuse range 402 and the nozzle use range 401 of the first pass set for the area 403 is set to the next area 404 for the first pass. Thereby, printing (3) in the forward direction can be performed to an area 404 adjacent to the area 403 that has been printed in the first and second passes by the set nozzle use range 401. In addition, printing is performed to the area 404 by setting the nozzle use range and the nozzle nonuse range which are the same as in the second pass in the area 403 in the backward scan (4) for the second pass to the area 404. Subsequently likewise, printing in the adjacent unit areas (403, 404, and so on) having the same width in the Y direction is sequentially performed by twice of scans.

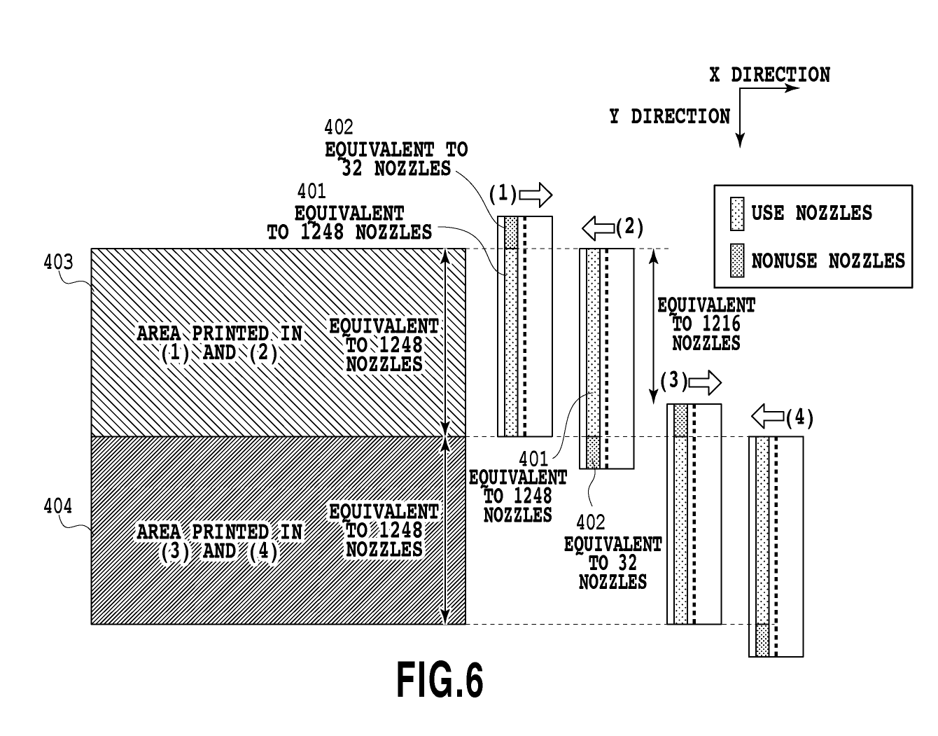

FIG. 6 is a diagram explaining specific sizes of the nozzle use range, the nozzle nonuse range, and the like in the printing operation of the present embodiment explained in FIG. 5. As shown in FIG. 6, in the present embodiment, the nozzle array of each ink color is constructed of 1280 nozzles. A length of the nozzle nonuse range 402 in the Y direction corresponding to the shift amount of the nozzle use range is an arrangement length of 32 nozzles (nozzle arrangement pitch equivalent to 32 nozzles; 32×nozzle arrangement pitch). This length is a print medium conveyance amount at transition from the first pass (1), (3), , , , to the second pass (2), (4), , , , in the printing of each unit area. A length of the nozzle use range 401 in the Y direction is a nozzle arrangement length of 1248 nozzles found by subtracting 32 nozzles from a total nozzle number of 1280 nozzles. Further, after the printing of each unit area is completed, the print medium conveyance amount at the time of transition to printing of the next unit area is a difference amount found by subtracting the nozzle arrangement length of the nozzle nonuse range 402 from the nozzle arrangement length of the nozzle use range 401. This conveyance amount is equivalent to a nozzle arrangement length of 1216 nozzles. As a result of the above printing operation, a length (width) of each of the unit areas 403 and 404 in the Y direction (conveyance) corresponds to a nozzle arrangement length of 1248 nozzles.

According to the printing operation in the present embodiment explained above, the effect of the multi-pass printing can be obtained and it is possible to suppress the inter-band unevenness which possibly occurs in the printing in the forward and backward scans.

In should be noted that in the present embodiment, the nozzle nonuse range is made up of 32 nozzles, but only in view of throughput of printing, as the nozzle nonuse range is the smaller, it is the better. However, it is preferable that, for obtaining the effect of the use nozzle dispersion by the multi-pass printing, nozzles having different ejection characteristics in the nozzle array are made associated with the same raster. Therefore, there may be a given limitation to the extent of reducing the nozzle nonuse range, for example, in the case that there is no large difference in ejection characteristics between neighboring nozzles for the reason of manufacturing the print head. In the present embodiment, in the nozzle arrangement of 1280 nozzles, the shift amount is made equivalent to a nozzle arrangement pitch corresponding to 32 nozzles. In this manner, the shift amount can be determined corresponding to a specification of the print head including manufacture accuracy of the print head or a specification of the printing apparatus using the print head.

### Second Embodiment

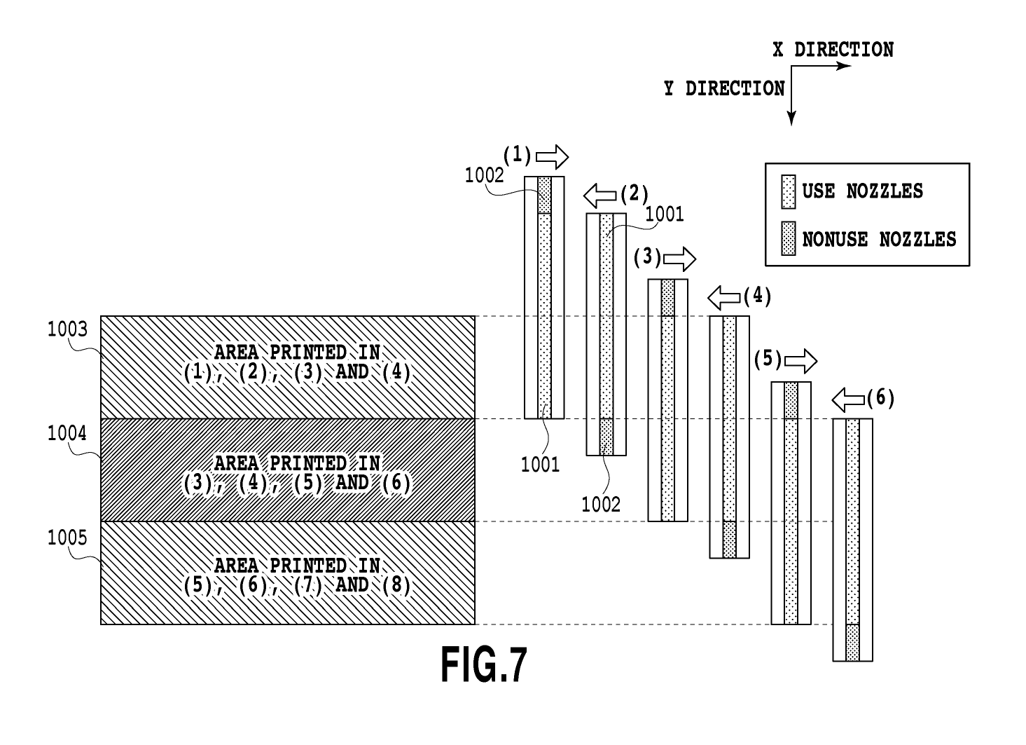

FIG. 7 is a diagram explaining a multi-pass printing operation according to a second embodiment of the present invention. The second embodiment of the present invention, as shown in FIG. 7, relates to a four-pass printing for completing printing of each unit area by four times of scans. Among four passes for completing printing in a unit area 1003 for example, a use range of nozzles is shifted between a first pass (1) and a second pass (2), and between a third pass (3) and a fourth pass (4), and the print medium is conveyed by an amount corresponding to a nozzle nonuse range. In addition, the print medium is conveyed by an amount found by subtracting the shift amount from the length of the unit area in the print medium conveyance direction to shift the nozzle use range.

Specially, as shown in FIG. 7, a nozzle use range 1001 and a nozzle nonuse range 1002 are set in the nozzles of the print head. Printing is performed by use nozzles thus set as described above in a forward direction printing (1) of the first pass. At this time, printing is performed in two unit areas. That is, the printing of the unit area corresponding to each of two nozzle ranges formed by equally dividing the nozzle use range 1001 into a half is performed. After the first pass is made, the print medium is conveyed by a nozzle arrangement length corresponding to the nozzle nonuse range 1002 in a direction opposing the Y direction. Along with this, a nozzle use range 1001 and a nozzle nonuse range 1002 for the second pass are set in the nozzles of the print head. The ranges set at this time correspond to the above shift amount. That is, these ranges are the same as the sizes of the ranges set for the first pass, that is, as the numbers of the nozzles, but ranges of nozzle set for each are different. Specially, in FIG. 7, the nozzle nonuse range 1002 for the first pass is set at the upper end side in the nozzle arrangement, and on the other hand, the nozzle nonuse range 1002 for the second pass is set at the lower end side in the nozzle arrangement. With the nozzle use range set in this manner, the forward direction printing (2) of the second pass is performed. Also at this time, printing is performed to two unit areas. In consequence, the two passes of the forward and backward directions enable the printing of the area 1003 having a width equivalent to an arrangement length of nozzles as a half of the nozzle use range to be completed. Next, the print medium is conveyed by a difference amount found by subtracting a nozzle arrangement length of the nozzle nonuse range 1002 from a half of a nozzle arrangement length of the nozzle use range 1001 in a direction (conveyance direction) opposing the Y direction. Along with it, the same ranges with each of the nozzle nonuse range 1002 and the nozzle use range 1001 of the first pass is set for the next third pass. Thereby, printing (3) of the forward direction can be performed by the set nozzle use range to an area 1004 adjacent to the area 1003 printed in the first pass and the second pass. Then, for the backward scan (4) of the fourth pass, printing is performed to the unit areas 1003 and 1004 by setting the nozzle use range and the nozzle nonuse range which are the same as in the second pass. At this point, the four-pass printing to the unit area 1003 is completed. Each raster in the unit area 1003 is printed by four different nozzles. Subsequently likewise, printing in the adjacent unit area (1004, 1005, and so on) having the same width in the Y direction is sequentially performed by four times of scans ((3), (4), (5), and (6)), ((5), (6), (7), and (8)), and so on.

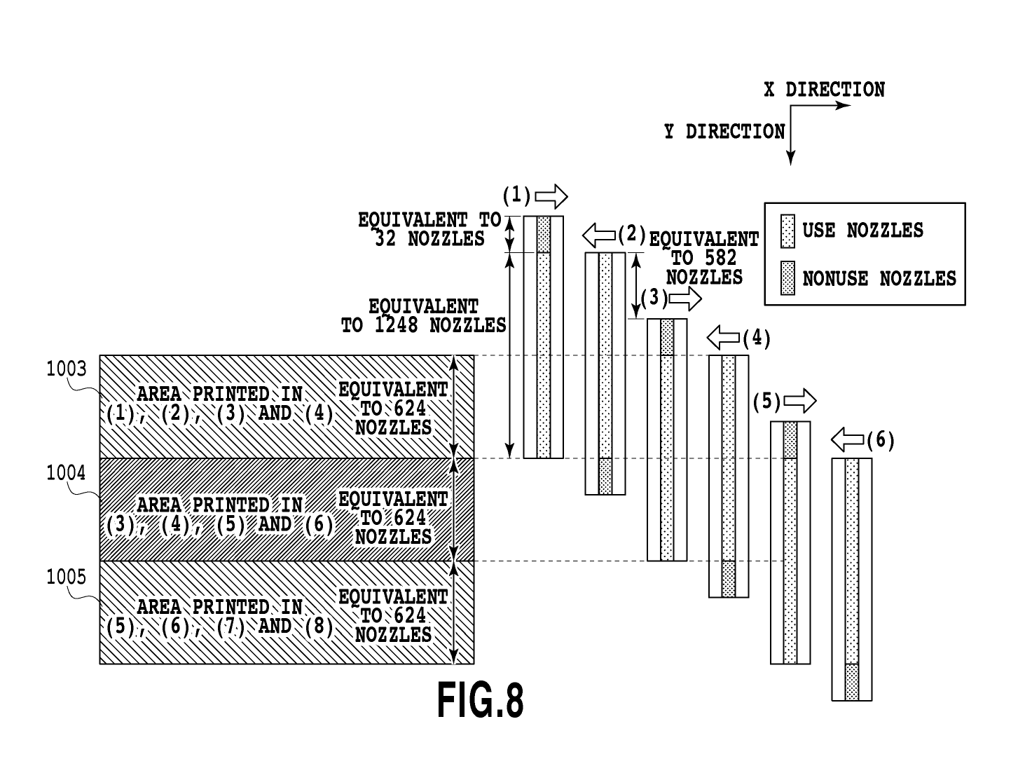

FIG. 8 is a diagram explaining specific sizes of the nozzle use range, the nozzle nonuse range, and the like in the printing operation of the present embodiment explained by referring to FIG. 7. As shown in FIG. 8, in the present embodiment, the nozzle array of each ink color is constructed of 1280 nozzles. A length the nozzle nonuse range 1002 in the Y direction corresponding to the shift amount of the nozzle use range is an arrangement length of 32 nozzles (nozzle arrangement pitch equivalent to 32 nozzles). This length is a print medium conveyance amount at transition from the first pass to the second pass and from the third pass to the fourth pass in the four-pass printing for each unit area. A length of the nozzle use range 1001 in the Y direction is a nozzle arrangement length of 1248 nozzles as a difference found by subtracting 32 nozzles from a total nozzle number of 1280 nozzles. This nozzle use range 1001 corresponds to two adjacent unit areas (1003 and 1004, and 1004 and 1005). That is, a length (width) of each unit area in the Y direction in which the printing is completed by four times of scans is a half of a nozzle arrangement length of 1248 nozzles. Further, after the printing of each unit area is completed by four passes (between the second pass and the third pass among the four passes), the print medium conveyance amount corresponds to a difference amount found by subtracting the nozzle arrangement length of the nozzle nonuse range 1002 from a half of the nozzle arrangement length of the nozzle use range 1001. In a case of the present embodiment, this length is a nozzle arrangement length of 582 nozzles. As a result of the above printing operation, a length (width) of each of the unit areas 1003, 1004, and 1005 in the Y direction (conveyance) is a nozzle arrangement length of 624 nozzles.

According to the printing in the present embodiment explained above, the effect of the multi-pass printing as similar to the first embodiment can be obtained and it is possible to suppress the inter-band unevenness which possibly occurs in the printing in the forward and backward scans.

The first and second embodiments of the present invention as explained above relate to the printing operation in which the print head, in which the plurality of nozzles for ejecting ink are arranged, reciprocally scans in a predetermined first direction (forward direction) and in a second direction (backward direction) opposing the first direction to complete printing in a unit area by a plurality times of scans. In addition, for example, as the first pass (1) and the second pass (2) to the area 403 shown in FIG. 5, a part of nozzles is not used in each pass, and the print medium is conveyed by an amount corresponding to the nonuse nozzle arrangement length between the first pass and the second pass. Such a configuration enables the nozzles for printing the same raster to be different between the first pass and the second pass. Specially, as shown in FIG. 5, in the first pass (1) a predetermined number of nozzles (32 nozzles) from the end of the downstream side in the conveyance direction of the nozzle array are defined as nonuse nozzles and nozzles (1248 nozzles) in a range excluding the nonuse nozzles maybe used, and in the second pass (2) a predetermined number of nozzles (32 nozzles) from the end of the upstream side in the conveyance direction of the nozzle array are defined as nonuse nozzles and nozzles (1248 nozzles) in a range excluding the nonuse nozzles may be used. Then, the print medium may be conveyed by an amount corresponding to predetermined number of nozzles between the first pass and the second pass. In view of throughput, as the nonuse nozzle number is the smaller, it is the more preferable, and it is preferable that the nonuse nozzle number is smaller than a width of the unit area in the conveyance direction.

In addition, in the above embodiments, since the printing is performed by the even times of scans starting with the scan in the forward direction in any unit area, the inter-band unevenness can be suppressed. In this case, as in the case of the first embodiment, the printing can be performed by performing the forward scan and the backward scan, respectively by one time to the unit area, and as in the case of the second embodiment, the printing can be performed by performing the forward scan and the backward scan, respectively by a plurality of times to the unit area.

### Third Embodiment

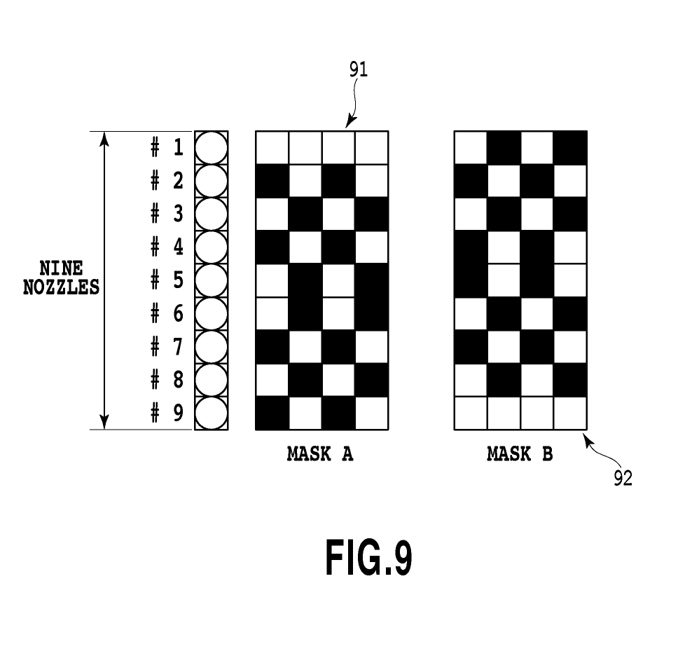

A third embodiment of the present invention relates to a printing data generation process of each pass in the multi-pass printing of two passes or four passes explained according to the aforementioned first and second embodiments. FIG. 9 is a diagram showing masks used in the two-pass printing explained by referring to FIG. 5, as an example. It should be noted that, for simplification of illustrations and explanations, the nozzle array of each ink color has nine nozzles, the nozzle use range has a nozzle arrangement length of eight nozzles, and the nozzle nonuse range has a nozzle arrangement length of one nozzle.

In FIG. 9, mask A is used for printing data generation in the first pass ((1) and (3) in FIG. 5) out of the two passes for completing the printing, and mask B is used for printing data generation in the second pass ((2) and (4) in FIG. 5) out of the two passes for completing the printing. A mask area shown in black in each mask is a printing allowable area for outputting printing data with the content of the printing data as it is, and a mask area shown in white in each mask is a printing non-allowable area for not outputting printing data regardless of the content of the printing data. Mask areas 91 and 92 forming a part of the printing non-allowable areas in the masks A and B correspond to the nozzle nonuse ranges.

As understood from FIG. 9, in the first pass, nozzle #1 becomes a nonuse nozzle and nozzles #2 to #9 become use nozzles by the mask A. Then, the mask A is used to perform data generation to printing (binary) data for the unit area 403 shown in FIG. 5 and a unit area adjacent thereto in the upper side in the figure, and thereby printing data in the first pass printed by the nozzle use range 401 (nozzle #2 to nozzle #9) can be obtained. In the next second pass, nozzle #9 becomes a nonuse nozzle and nozzles #1 to #8 become use nozzles by the mask B. Then, the mask B is used to perform data generation to printing data corresponding to the nozzle nonuse range in each of the unit area 403 shown in FIG. 5 and the unit area 404 adjacent thereto in the lower side in the figure, for example. Thereby, printing data for the second pass printed by the nozzle use range 401 (nozzle #1 to nozzle #8) can be obtained. The printing allowable areas corresponding to nozzle #2 to nozzle #9 in the mask A has a mutually complementary relation to the printing allowable areas corresponding to nozzle #1 to nozzle #8 in the mask B, and therefore, the printing can be completed for the unit area corresponding to the nozzle use ranges by twice scans.

### Fourth Embodiment

A fourth embodiment of the present invention relates to a mode where a so-called connection process is used along with the printing process of each in the aforementioned first to third embodiments. Here, the connection process is a process for reducing stripe like density unevenness (hereinafter, also called connection stripe) possibly generated in the boundary or in the neighborhood of the boundary between unit areas (hereinafter, also called bands). It is known that the connection stripe is generated by ink bleed in the boundary between bands. In the present embodiment, for example, the boundary between the unit area 403 and the unit area 404 shown in FIG. 5 is a place where the connection stripe is possibly generated.

A method of reducing the connection stripe is described in Japanese Patent Laid-Open No. H11-188898 (1999), and herein it is performed to thin out ink dots to be printed in the connection part in accordance with an amount of ink to be ejected to the printing area in the boundary neighborhood (hereinafter, also called connection part). According to a method described in Japanese Patent Laid-Open No. 2002-96460, information in regard to a relative ejecting amount of inks of a plurality of colors for printing the connection part is obtained for correction. The present embodiment uses such a connection process together with printing process.

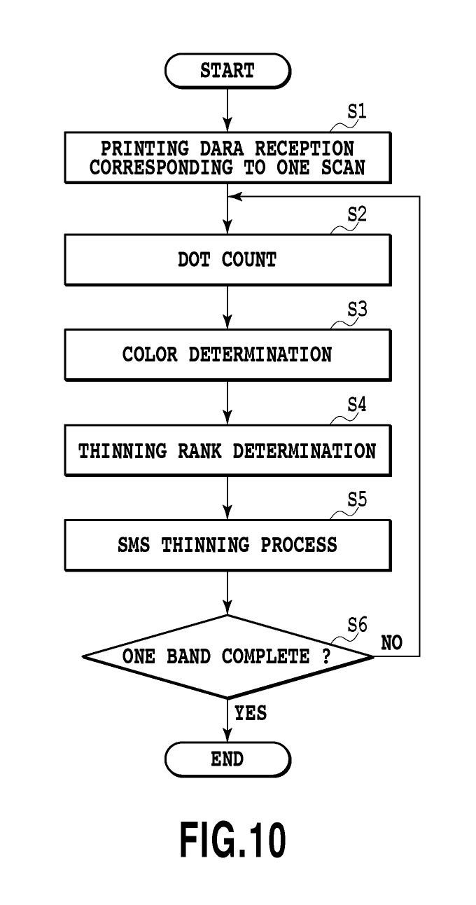

FIG. 10 is a flow chart showing the connection process. That is, in the printing process explained by referring to FIG. 5, the connection process is performed between the respective unit areas, such as between the unit area 403 and the unit area 404. The present example uses a method substantially similar to the method described in Japanese Patent Laid-Open No. H11-188898 (1999).

FIG. 10 shows a routine from reception of printing data corresponding to one scan to completion of a printing data process, wherein, first, in step S1, printing data of an amount necessary for printing of one scan corresponding to ink of each color is received. Data corresponding to one band and further, data corresponding to a dot count area of the next band are required for the printing of one scan. In step S2, dots (data showing the ink ejection) are counted in the count area, that is, in each area of 16 pixels×16 rasters. Next, in step S3, a color determination process is performed, in step S4, a thinning rank determination process is performed, and in step S5, an SMS thinning process is performed. In step S6, the above processes are repeated until those corresponding to one band are completed. Hereinafter, the details of each process will be explained.

In the present embodiment, the dot count area is defined as a width corresponding to 16 rasters including the connection part of the bands. The dot count is made in binary data of all inks of the print head used in the present embodiment, that is, each color of cyan, magenta, yellow and black, and a sum of the dot count numbers obtained from the respective dot counts is set as a dot count value as a result of the dot counts (or total dot count value). Here, by supplementing the dot count value, the event “the dot count value is one” shows the event “one dot exists in one pixel” and the event “the dot count value is two” shows the event “two dots exist in one pixel”. The dot count is made in the divided area in the neighborhood of the connection part, and the size is designed as an area corresponding to 16 rasters in the discharge direction and 16 dots in the carriage scan direction. In the process of the present embodiment, the thinning rank is determined based upon the total dot count value obtained from the dot count to perform the SMS thinning. In addition, it is possible to obtain relative information showing a relative relation in amounts between respective inks struck into the count area, from the dot count value of each color. Such processes are repeated in all areas of one band and further the processes are performed to all the bands corresponding to one page, thus generating the printing data.

The area covering across the connection part is provided as a dot count unit area, and thereby a state of printing dots across the connection part can be obtained. That is, it can be determined whether or not the ink ejecting causing the connection stripe to be easily generated is performed, which enables the connection stripe process to be performed with higher accuracy. In a case of performing the dot count only within one band, an ink spread amount as a factor causing the connection stripe within the area can be estimated, but an influence degree on the next band can not be comprehended. A generation level of the connection stripe depends on an ink amount in the neighborhood of the connection part to the next band. For example, in a case of ejecting some degrees of ink to the next band, the connection stripe tends to be easily generated by spread of mutual inks, but in a case of a small amount of the ejection ink, although there is a possibility that the ink spread of the band previously struck is generated, there is a few possibility that it is formed as the connection stripe. It is effective to reduce an ink amount of either one of the front and back bands, that is, thin out the printing data. In addition, the thinning process may be performed to either one or both of the front and back bands. As described above, the generation of the connection stripe is due to the ink amount of the bands before and after the connection part, and by setting the area covering across the connection part as the dot count unit area, it is possible to improve a control efficiency of the connection stripe process for performing an effective connection process.

Next, in the color determination, color visibility in the area can be determined based upon the dot count result.

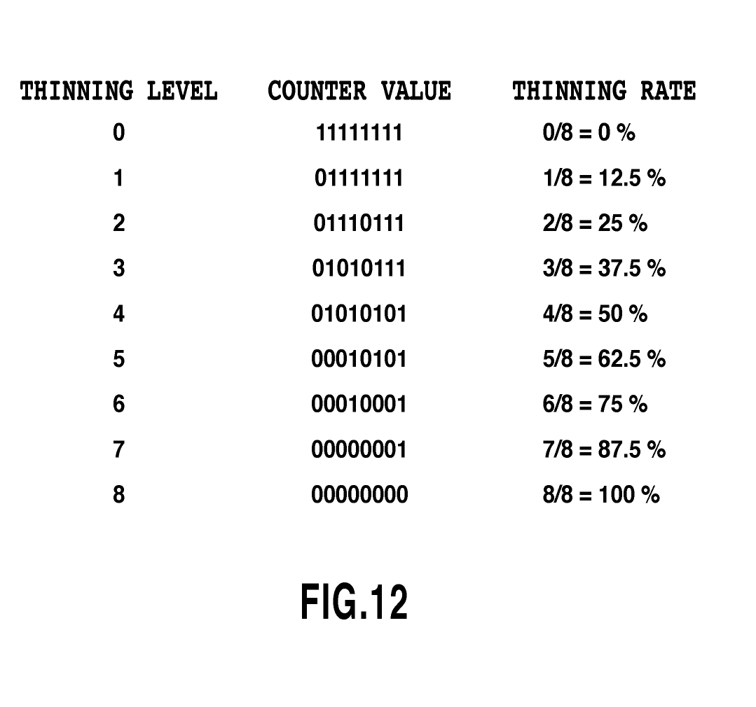

Further, in the thinning rank determination, an instruction of a thinning rate of data is made from a total dot count value in the count area obtained from the dot count. The rank has nine steps made up of the thinning rate of 0% to the thinning rate of 100%. FIG. 12 shows an example of a relation between the thinning level and the thinning rate. The count value is a value used for the thinning process and is an 8-bit value.

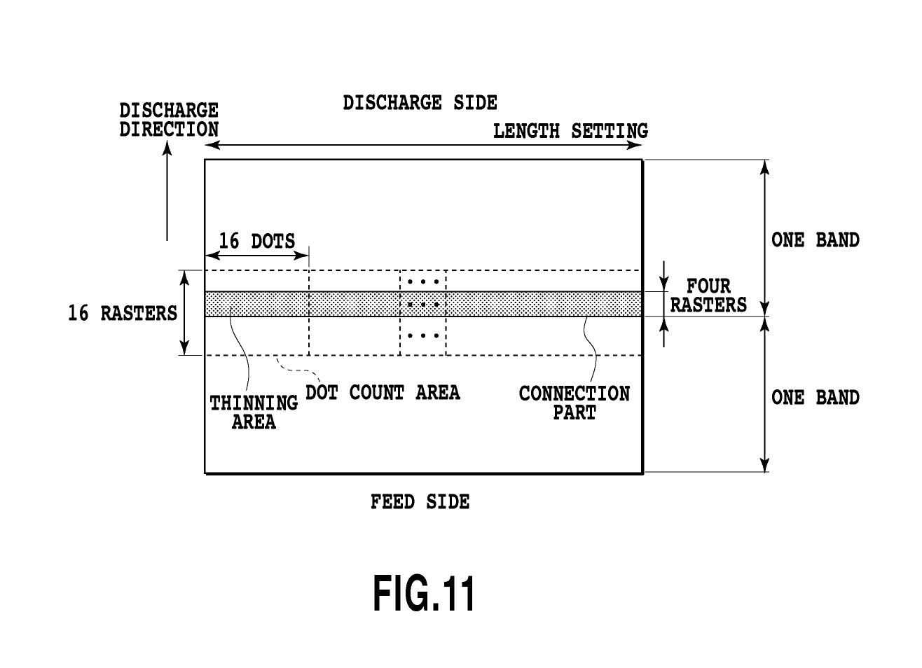

The thinning process is, as shown in FIG. 11, performed to an area of one band corresponding to four rasters in the feed side, wherein an area corresponding to 16 dots is pointed out as a process area in the scan direction. Further, the four rasters to be processed are divided into two areas such as two rasters in the discharge side (indicated also as upper) and two rasters in the feed side (indicated also as lower). Different thinning rank graphs are prepared such that the thinning rank can be determined in each area. As understood from FIG. 11, the thinning area and the dot count area are not the same area, and a part of the dot count area corresponds to the thinning area. In this manner, it is not necessary that the thinning area is in agreement with the dot count area. This is thought because the connection stripe is not a simple phenomenon of being generated only in the connection part, and ink spread between mutual bands and spread-out of ink from a portion away by a several rasters from the connection part are transmitted in a chain reaction way corresponding to a connecting state of dots. For example, a state of connection stripes is different between a case where the ink is struck in an area corresponding to four rasters from the connection part and a case where the ink is struck in an area corresponding to eight rasters from the connection part. The more serious connection stripe is formed in the latter case. This is because the spread from a portion away by a several rasters from the connection part is gradually transmitted and an ink amount in the connection part is relatively large, therefore causing connection stripe to be more easily generated. Therefore, it is desired that the dot count area is set larger than the thinning area, which is preferably set as an area in consideration of chain-reaction transmission of the ink spread. In the present embodiment, the dot count area is double as large as the thinning area.

In regard to the thinning area, it is necessary to form an area having a size of some degrees as the thinning area for effectively performing the connection stripe process. In reverse, when the thinning area is formed extremely largely, the thinning process possibly causes a density reduction depending on the thinning process, inducing white stripes as an image defect in some cases. An appropriate width of the thinning area is determined based upon the above factor and the ink characteristics. In the present embodiment, four rasters (width of about 0.17 mm at 600 dpi) are set as the thinning area as similar to Japanese Patent Laid-Open No. H11-188898 (1999), which are a width of a range in which the effect of the connection stripe suppression is achieved and the white stripe is not induced.

The SMS thinning process reads a count value (specific bit, herein MSB) pointed by a counter (register) for each time printing data exists. When the count value is one, the printing data is printed, and the counter is shifted by one to the right. When the count value is zero, the printing data is thinned out, and the counter is shifted by one to the right. When the counter shifts to the rightmost, the counter returns back again to the leftmost. The SMS thinning process is a method of fixing the thinning dot by repeating this process for each time the printing data comes. The connection stripe can be reduced by performing the above process for each scan.

The connection process as described above has superior compatibility with the present invention. The inter-band unevenness is relatively gradual unevenness which is repeatedly visualized in a band width. On the other hand, the connection stripe is visualized on a relatively thin stripe and the correction range is also the order of four rasters in the above example. That is, even if the overlapping way of the order of four rasters in the band boundary part is defined with priority of the connection stripe improvement effect, the effect of the present invention does not disappear. That is, it can be said that the present invention can be used together with the connection process.

For example, in each example shown in FIG. 5 and FIG. 6, the printing area of 1248 nozzles used in the first pass overlaps that of the second pass, but in regard to several rasters at both ends, the thinning process may be performed with priority of the connection stripe. This is because there are some cases where it is more effective that the area of the order of four rasters aims at the connection stripe reduction effect than the inter-band unevenness reduction effect. For example, when the thinning level is maximized (when the thinning is carried out for each raster), it is possible to reduce the number of use nozzles in each of the first pass and the second pass to 1247 nozzles, 1246 nozzles or the like. Therefore, when the connection stripe is more highly visible than the inter-band unevenness, it is possible to keep a state of eliminating the inter-band unevenness in a larger cycle while moving the boundary part.

### Other Embodiment

Each of the aforementioned embodiments is designed to use the print head equipped with the respective nozzle arrays of cyan (C), magenta (M), yellow (Y), and black (K), but the construction of the print head applicable to the present invention is not limited thereto without mentioning. For example, a print head corresponding to six colors equipped further with nozzle arrays of light cyan and light magenta may be used. The present invention can be widely applied to the construction of the print head in which the inter-band unevenness is possibly generated and which is equipped with a plurality of nozzle arrays ejecting inks of different colors.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-020824, filed Feb. 2, 2011, which is hereby incorporated by reference herein in its entirety.

What is claimed is:

1. An ink jet printing apparatus that performs scans of a print head, in which a plurality of nozzle arrays for ejecting different colors of inks from each other in a predetermined direction, in a first direction that is the predetermined direction and in a second direction opposing the first direction, and conveys a print medium in a conveyance direction crossing the predetermined direction, to print an image to the print medium, said apparatus comprising:
a printing unit configured to perform printing to a unit area of the print medium by using a range of nozzles that is obtained by excluding a predetermined number of nozzles from the end of a downstream side in the conveyance direction of the nozzle array from nozzles in each of the plurality of nozzle arrays, in a scan of the first direction, and to perform printing to the unit area of the print medium by using a range of nozzles that is obtained by excluding the predetermined number of nozzles from the end of a upstream side in the conveyance direction of the nozzle array from nozzles in each of the plurality of nozzle arrays, in a scan of the second direction; and
a conveying unit configured to convey the print medium by an amount corresponding to a nozzle arrangement length of the predetermined number of nozzles, between the scan of the first direction and the scan of the second direction.

2. An ink jet printing apparatus that performs scans of a print head, in which a plurality of nozzle arrays for ejecting different colors of inks from each other in a predetermined direction, in a first direction that is the predetermined direction and in a second direction opposing the first direction, and conveys a print medium in a conveyance direction crossing the predetermined direction, to print an image to the print medium, said apparatus comprising:
a printing unit configured to execute a first step that performs printing to a unit area of the print medium by using a range of nozzles that is obtained by excluding a predetermined number of nozzles from the end of a downstream side in the conveyance direction of the nozzle array from nozzles in each of the plurality of nozzle arrays, in a scan of the first direction, and a second step that performs printing to the unit area of the print medium by using a range of nozzles that is obtained by excluding the predetermined number of nozzles from the end of a upstream side in the conveyance direction of the nozzle array from nozzles in each of the plurality of nozzle arrays, in a scan of the second direction; and
a conveying unit configured to convey the print medium by an amount corresponding to a nozzle arrangement length of the predetermined number of nozzles, between the first step and the second step.

3. The ink jet printing apparatus according to claim 2, wherein said conveying unit conveys the print medium by an amount corresponding to a nozzle arrangement length found by subtracting the arrangement length of the predetermined number of nozzles from a nozzle arrangement length of the range of nozzles obtained by excluding the predetermined number of nozzles from the nozzles in each of the plurality of nozzle arrays, between a set of the first and second steps and a next set of the first and second steps, and said printing unit executes the first step and the second step one time each to complete printing of the unit area.

4. The ink jet printing apparatus according to claim 2, wherein said conveying unit conveys the print medium by an amount less than an amount corresponding to a nozzle arrangement length found by subtracting the arrangement length of the predetermined number of nozzles from a nozzle arrangement length of the range of nozzles obtained by excluding the predetermined number of nozzles from the nozzles in each of the plurality of nozzle arrays, between a set of the first and second steps and a next set of the first and second steps, and
said printing unit executes the first step and the second step plural times each to complete printing of the unit area.

5. The ink jet printing apparatus according to claim 2, wherein said printing unit, when generating print data to be printed in the first and second steps, thins out print data for a neighborhood of a boundary between the unit areas adjacent to each other.

6. The ink jet printing apparatus according to claim 2, wherein a range of the predetermined number of nozzles in the conveyance direction is smaller than a width of the unit area along the conveyance direction.

7. An ink jet printing method of performing scans of a print head, in which a plurality of nozzle arrays for ejecting different colors of inks from each other in a predetermined direction, in a first direction that is the predetermined direction and in a second direction opposing the first direction, and of conveying a print medium in a conveyance direction crossing the predetermined direction, to print an image to the print medium, said method comprising:
a first step of performing printing to a unit area of the print medium by using a range of nozzles that is obtained by excluding a predetermined number of nozzles from the end of a downstream side in the conveyance direction of the nozzle array from nozzles in each of the plurality of nozzle arrays, in a scan of the first direction, and
a second step of performing printing to the unit area of the print medium by using a range of nozzles that is obtained by excluding the predetermined number of nozzles from the end of a upstream side in the conveyance direction of the nozzle array from nozzles in each of the plurality of nozzle arrays, in a scan of the second direction; and
a conveying step of conveying the print medium by an amount corresponding to a nozzle arrangement length of the predetermined number of nozzles, between the first step and the second step.

8. The ink jet printing method according to claim 7, wherein said conveying step conveys the print medium by an amount corresponding to a nozzle arrangement length found by subtracting the arrangement length of the predetermined number of nozzles from a nozzle arrangement length of the range of nozzles obtained by excluding the predetermined number of nozzles from the nozzles in each of the plurality of nozzle arrays, between a set of the first and second steps and a next set of the first and second steps, and wherein the first step and the second step are executed one time each to complete printing of the unit area.

9. The ink jet printing method according to claim 7, wherein said conveying step conveys the print medium by an amount less than an amount corresponding to a nozzle arrangement length found by subtracting the arrangement length of the predetermined number of nozzles from a nozzle arrangement length of the range of nozzles obtained by excluding the predetermined number of nozzles from the nozzles in each of the plurality of nozzle arrays, between a set of the first and second steps and a next set of the first and second steps, and wherein the first step and the second step are executed plural times each to complete printing of the unit area.

10. The ink jet printing method according to claim 7, wherein when generating print data to be printed in the first and second steps, print data for a neighborhood of a boundary between the unit areas adjacent to each other is thinned out.

11. The ink jet printing method according to claim 7, wherein a range of the predetermined number of nozzles in the conveyance direction is smaller than a width of the unit area along the conveyance direction.
